(19) United States
(12) Patent Application Publication
(10) Pub. No.: US 2026/0183708 A1
(43) Pub. Date: Jul. 2, 2026

(54) POINT SOURCE CARBON CAPTURE SYSTEMS

(71) Applicant: CORMETECH, INC., Durham, NC (US)

(72) Inventors: Chris Bertole, Durham, NC (US); Chris DiFrancesco, Durham, NC (US)

(21) Appl. No.: 19/130,416

(22) PCT Filed: Nov. 15, 2023
(86) PCT No.: PCT/US2023/079881

§ 371 Date: May 15, 2025

Related U.S. Application Data
(60) Provisional application No. 63/425,549, filed on Nov. 15, 2022.

(51) Int. Cl. B01D 53/62; B01D 46/00; B01D 53/34; B01D 53/82; B01D 53/96; B01J 20/26; B01J 20/28; C01B 32/50

(52) U.S. Cl. CPC B01D 53/62; B01D 46/0036; B01D 53/343; B01D 53/82; B01D 53/96; B01J 20/262; B01J 20/28011; B01J 20/28045; C01B 32/50; B01D 2253/202; B01D 2253/3425; B01D 2257/504; B01D 2259/4009; C01P 2006/80

(57) ABSTRACT

In one aspect, methods are described herein for the removal of CO₂ from flue gas or exhaust gas streams generated from point sources including, but not limited to, electric generation facilities, concrete production facilities, chemical and food processing facilities. A method, in some embodiments, a method comprises an adsorption cycle for removing at least 70 percent of CO₂ from an exhaust gas stream. The adsorption cycle includes flowing an exhaust gas stream through at least one adsorber bed formed of monolithic structural adsorbers, the monolithic structural adsorbers comprising an outer peripheral wall and a plurality of inner partition walls supporting an organic compound or inorganic compound adsorbing CO₂ from the exhaust gas stream.

### RELATED APPLICATION DATA

The present claims priority pursuant to Article 8 of the Patent Cooperation Treaty to U.S. Provisional Patent Application Ser. No. 63/425,549 filed Nov. 15, 2022 which is incorporated herein by reference in its entirety.

### FIELD

The present application related to carbon capture technologies and, in particular, to technologies for the removal and capture of carbon dioxide (CO₂) from point source flue gas streams.

### BACKGROUND

Global warming and associated climate change induced by human activities presents an existential threat to numerous ecosystems and the way of human life as it is currently understood. The mining and burning of fossil fuels are chief contributors global warming via the massive release of heat trapping gases, including methane and CO₂. CO₂ accounts for the bulk of greenhouse gas emissions, as the concentration of CO₂ has eclipsed the 400 ppm mark in recent years. Current CO₂ levels exceed any concentration in the last 800,000 years.

In view of this alarming trend in atmospheric CO₂ concentration, countries and industry have initiated various mitigation strategies to reduce CO₂ emissions, as well as methane emissions. Electrification of vehicles and transportation systems has drawn considerable attention. Moreover, the transition to green/renewable sources of energy, including wind and solar, has received significant private and public investment. While promising, these mitigation strategies fail to address CO₂ that is currently in the atmosphere as well as CO₂ being generated via current fossil fuel consumption. Accordingly, existing carbon dioxide levels are left to slow, natural degradation processes.

### SUMMARY

In one aspect, methods are described herein for the removal of CO₂ from flue gas or exhaust gas streams generated from point sources including, but not limited to, electric generation facilities, concrete production facilities, chemical and food processing facilities. Such CO₂ removal is generally referred to as point source capture. A method, in some embodiments, a method comprises an adsorption cycle for removing at least 70 percent of CO₂ from an exhaust gas stream. The adsorption cycle includes flowing an exhaust gas stream through at least one adsorber bed formed of monolithic structural adsorbers, the monolithic structural adsorbers comprising an outer peripheral wall and a plurality of inner partition walls supporting an organic compound or inorganic compound adsorbing CO₂ from the exhaust gas stream, wherein the exhaust gas stream has an inlet temperature of at least 60° C., a CO₂ content of 3-20 percent, and a water vapor content of 2-22 percent. The adsorber bed is isolated from the exhaust gas stream, and steam having a pressure of −2 psig to 2 psig and a maximum temperature of 120° C. is flowed through the adsorber bed in a direction opposite the exhaust gas stream flow to desorb the CO₂ captured by the adsorber bed by providing enthalpy for CO₂ desorption. A first portion of the steam is condensed in pores of the monolithic structural adsorbers, and a second portion of the steam sweeps the desorbed CO₂ from the adsorber bed to provide a mixture of the desorbed CO₂ and sweeping steam. The CO₂ is then separated from the mixture, thereby providing a product gas with at least 90 percent CO₂ by weight. Isolation of the adsorber bed from the exhaust has stream is discontinued, and the exhaust gas stream re-enters the monolithic structural adsorbers to evaporate the condensed steam in the pores and cool the adsorbers to a temperature less than 90° C. to begin a new adsorption cycle.

In some embodiments, methods described herein employ at least two adsorber beds, wherein at any given time, a first adsorber bed is removing CO₂ from the exhaust gas stream, while a second adsorber bed is isolated from the exhaust gas stream and desorbing CO₂ captured by the monolithic structural adsorbers. The CO₂ adsorption by the first bed and the CO₂ desorption from the second bed occurs according to the procedure detailed above.

Moreover, in some embodiments, a condensing heat exchanger is positioned downstream of the one or more adsorber beds. The heat exchanger, in some embodiments, is operable to recover water vapor in the exhaust gas stream from the combustion process, and/or condensed steam that has evaporated from the monolithic structural adsorbers of the bed(s).

These and other embodiments are further described in the following detailed description.

### BRIEF DESCRIPTION OF THE DRAWINGS

FIG. 1 illustrates a honeycomb-like monolithic structural adsorber according to some embodiments herein.

FIG. 2 illustrates flow channels 12 defined by the inner partition walls 11 in a honeycomb-like monolithic structural catalyst body according to some embodiments herein.

FIG. 3 illustrates a method of determining the average thickness of the outer peripheral wall 10 and inner partition walls 11.

FIG. 4 illustrates a plan view of a module containing monolithic structural adsorbers according to some embodiments.

FIG. 5 is a schematic illustrating methods described herein, according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In one aspect, methods are described herein for the removal of CO₂ from flue gas or exhaust gas streams generated from point sources including, but not limited to, electric generation facilities, concrete production facilities, chemical and food processing facilities. A method, in some embodiments, a method comprises an adsorption cycle for removing at least 70 percent of CO₂ from an exhaust gas stream. The adsorption cycle includes flowing an exhaust gas stream through at least one adsorber bed formed of monolithic structural adsorbers, the monolithic structural adsorbers comprising an outer peripheral wall and a plurality of inner partition walls supporting an organic compound or inorganic compound adsorbing CO₂ from the exhaust gas stream, wherein the exhaust gas stream has an inlet temperature of at least 60° C., a CO₂ content of 3-20 percent, and a water vapor content of 2-22 percent. The adsorber bed is isolated from the exhaust gas stream, and steam having a pressure of −2 psig to 2 psig and a maximum temperature of 120° C. is flowed through the adsorber bed in a direction opposite the exhaust gas stream flow to desorb the CO₂ captured by the adsorber bed by providing enthalpy for CO₂ desorption. A first portion of the steam is condensed in pores of the monolithic structural adsorbers, and a second portion of the steam sweeps the desorbed CO₂ from the adsorber bed to provide a mixture of the desorbed CO₂ and sweeping steam. The CO₂ is then separated from the mixture, thereby providing a product gas with at least 90 percent CO₂ by weight. Isolation of the adsorber bed from the exhaust has stream is discontinued, and the exhaust gas stream re-enters the monolithic structural adsorbers to evaporate the condensed steam in the pores and cool the adsorbers to a temperature less than 90° C. to begin a new adsorption cycle.

Turning now to specific components, adsorber beds employed in point source capture methods described herein employ monolithic structural adsorbers. The monolithic structural adsorbers comprising an outer peripheral wall and a plurality of inner partition walls supporting an organic compound or inorganic compound adsorbing CO₂ from the exhaust gas stream. The outer peripheral wall, and a plurality of inner partition walls, in some embodiments, have dispersed throughout a carrier comprising an inorganic oxide composition. In being dispersed throughout the outer peripheral wall and inner partition walls, the carrier comprising the inorganic oxide composition, in some embodiments, forms the outer partition wall and inner partition walls. The carrier can include any inorganic oxide not inconsistent with the technical objectives described herein. In some embodiments, the inorganic oxide comprises at least one of titania (TiO₂), alumina (Al₂O₃), and zirconia (ZrO₂). In some embodiments, the inorganic oxide composition is titania based or alumina based. Alumina of the inorganic oxide can comprise one or more polymorphs, including gamma alumina. In being titania or alumina based, titania or alumina is the inorganic oxide present in the highest amount of the composition. In some embodiments, for example, an alumina based inorganic oxide composition comprises alumina in an amount of 40-100 wt. %. Similarly, a titania based inorganic oxide composition, in some embodiments, comprises titania in an amount of 40-100 wt. %.

The carrier, in some embodiments, comprises the inorganic oxide composition in an amount of 50-100 wt. %. In some embodiments, the inorganic oxide of the carrier does not substantially include oxides of tungsten, vanadium, and/or molybdenum. For example, the inorganic oxide of the carrier comprises less than 5 wt. %, less than 3 wt. %, less than 1 wt. % of oxides of tungsten, vanadium, and/or molybdenum. Moreover, the inorganic oxide composition, in some embodiments, includes less than 100 ppm iron or iron compounds, the iron or iron compounds operable for the oxidation and/or other degradation of CO₂ capture functionalities, such as amine functionalities, associated with the carrier. The carrier may further comprise fillers and/or reinforcement agent, as described further herein.

The carrier, in some embodiments, exhibits a hierarchical pore structure having a macroporosity of at least 0.05 cc/g in pores of diameter ranging from 600 to 5,000 Angstroms. In some embodiments, the macroporosity ranges from 0.05-0.3 cc/g or 0.08 to 0.2 cc/g in pores of 600 to 5,000 Angstroms. In some embodiments, macroporosity of the carrier comprises a first porosity distribution of at least 0.08 cc/g in pores of diameter ranging from 600 to 5,000 Angstroms, and a second porosity distribution of at least 0.16 g/cc in pores of diameter ranging from greater than 5,000 Angstroms up to 50,000 Angstroms, wherein the summation of the first and second porosity distributions falls within a total macroporosity range of 0.24 to 1.0 cc/g. In some embodiments, the macroporosity is bimodal or multimodal, wherein the sum of the individual modes yields the total macroporosity. The first porosity distribution, in some embodiments, is greater than the second porosity distribution of the macroporosity. Alternatively, the second porosity distribution of the macroporosity can be greater than the first porosity distribution.

In addition to macroporosity, the carrier can have a mesoporosity of at least 0.15 cc/g or at least 0.20 cc/g in pores of diameter ranging from 20 to 500 Angstroms. In some embodiments, the carrier has mesoporosity of at least 0.30 cc/g in pores of 20 to 500 Angstroms. Mesoporosity of the carrier can also have a value selected from Table 1.

TABLE 1
Mesoporosity of Carrier in pores of diameter
ranging from 20 to 500 Angstroms
0.15-0.70
0.20-0.60
0.20-0.55
0.20-0.50
0.25-0.45
0.30-0.55
0.35-0.60
0.15-0.30
0.15-0.25

A ratio of mesoporosity to macroporosity of the carrier can be greater than 1, such as greater than 1.1 or greater than 1.2. In other embodiments, the ratio of mesoporosity to macroporosity of the carrier is less than 1, such as 0.5 to 0.8. Macroporosity of the carrier can be measured via mercury porosimetry, while mesoporosity can be measured by nitrogen (N₂) adsorption.

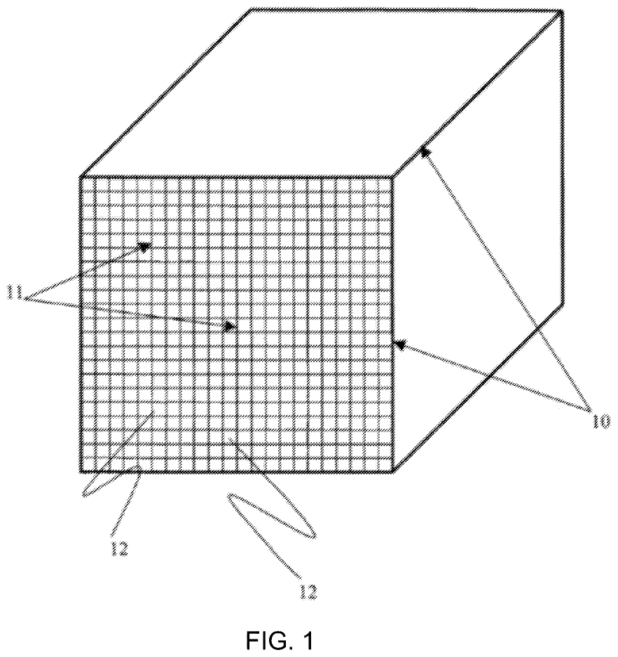

As described herein, the carrier having the foregoing hierarchical pore structure is dispersed throughout the outer peripheral wall and inner partition walls of the monolithic structural adsorber. In some embodiments, the carrier comprising the inorganic oxide composition forms the outer peripheral wall and inner partition walls of the monolithic structural adsorber. The inner partition walls are arranged inside the dimensions defined by the outer peripheral wall, and plurality of flow channels are defined by the inner partition walls, the flow channels extending longitudinally through the monolithic structural adsorber. FIG. 1 illustrates a honeycomb-like monolithic structural adsorber according to some embodiments herein. The honeycomb-like structural adsorber in the embodiment of FIG. 1 comprises an outer peripheral wall 10 and a plurality of inner partition walls 11. The inner partition walls 11 define a plurality of flow channels 12 extending longitudinally through the honeycomb-like monolithic structural adsorber.

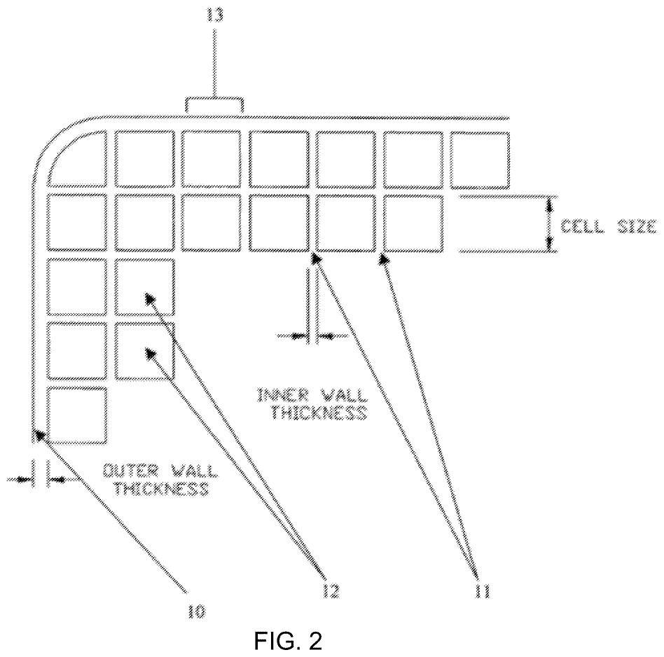

FIG. 2 illustrates flow channels 12 defined by the inner partition walls 11 in a honeycomb-like monolithic structural catalyst body according to some embodiments herein. The inner partition walls 11 and their junctures with the outer peripheral wall serve as boundaries for adjacent flow channels 12. When a portion of the outer peripheral wall 10 serves as a boundary for a flow channel 12, that portion may be referred to as an outer peripheral wall segment 13. As illustrated in FIGS. 1 and 2, the flow channels 12 establish a flow channel density or cell density over the inlet and outlet faces of the monolithic structural adsorber. A monolithic structural adsorber described herein can have any desired cell density or flow channel density. As described above, the monolithic structural adsorber has a cell density of at least 85 cpsi. In some embodiments, the monolithic structural adsorber has a cell density of 100 cpsi to 900 cpsi. For example, the monolithic structural adsorber can have a cell density of 100 cpsi to 500 cpsi, 140 cpsi to 450 cpsi, or 170 cpsi to 500 cpsi. Additionally, length of the flow channels or cells, in some embodiments, is at least 100 mm or at least 110 mm. In some embodiments, length of the flow channels of cells of the monolithic structural has treatment body is at least 120 mm or at least 125 mm.

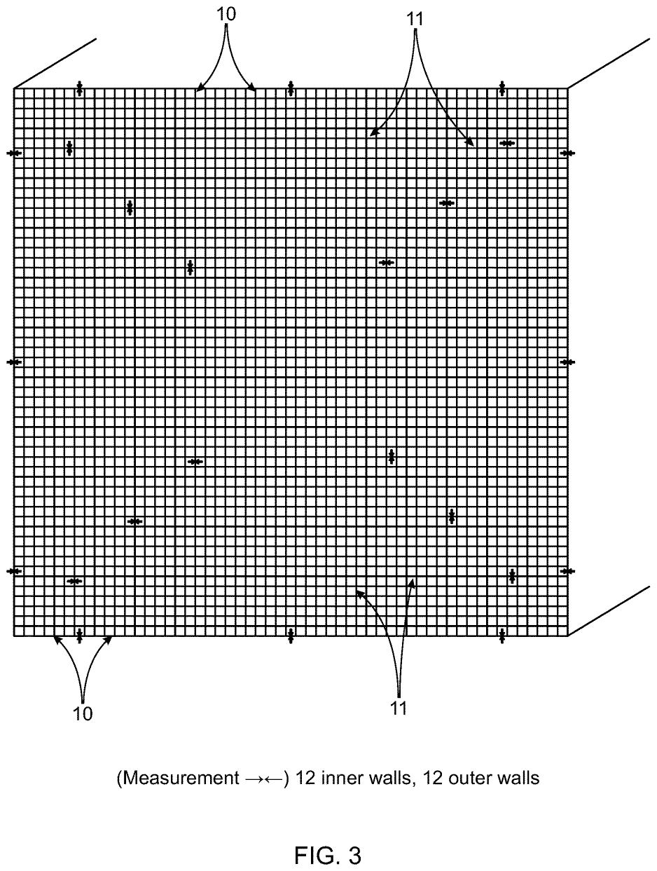

Moreover, as provided above, the inner partition wall thickness of a monolithic structural adsorber is 0.1 mm to 0.3 mm. In some embodiments, the inner partition wall thickness can be 0.1 mm to 0.25 mm, 0.1 mm to 0.2 mm, 0.1 mm to 0.25 mm, 0.15 mm to 0.25 mm, or 0.15 mm to 0.2 mm. The thickness of the outer peripheral wall and inner partition walls are determined with a caliper or micrometer with a resolution of 0.01 mm. FIG. 3 illustrates a method of determining the average thickness of the outer peripheral wall 10 and inner partition walls 11. The thickness of the outer peripheral wall 10 is measured in twelve (12) different locations on the catalyst body sample. The twelve measuring locations comprise three points on each side of the square outer peripheral wall as demonstrated in FIG. 3. The average thickness of the outer peripheral wall 10 is calculated by averaging the values obtained from the twelve (12) measurements. Similarly, the average thickness of the inner partition walls 11 is determined by initially measuring the thickness of the inner partition walls 11 at twelve (12) different locations throughout the catalyst body. The inner partition walls 11 are measured in the horizontal and vertical directions as displayed in FIG. 3. The average thickness of the inner partition walls 11 is calculated by averaging the values obtained in the twelve measurements.

Thin inner partition walls can assist in achieving high cpsi without sacrificing open frontal area of the monolithic structural adsorber and/or inducing undesirable pressure drop sustained by gas flow through the monolithic structural body. The open frontal area (OFA) of the monolithic structural adsorber is that portion of the body cross-section available for gas flow on a cross-sectional surface normal to the direction of gas flow. An increased open frontal area can result in more efficient fluid flow characteristics within the monolithic body, which can decrease the pressure drop sustained by fluids passing through the monolithic structural adsorber. A monolithic structural adsorber described herein has an OFA of at least 65 percent. In some embodiments, a monolithic structural adsorber has an OFA of at least 70 percent or at least 80 percent. OFA of a monolithic structural adsorber can range from 65-90 percent, 65-85 percent, 70-90 percent, 70-80 percent, 75-85 percent, or 80-90 percent, in some embodiments.

As described above, a monolithic structural adsorber also has a hydraulic diameter of at least 100 mm. The hydraulic diameter of the catalyst body is defined as being equal to the cross-sectional area perpendicular to the direction of flow of the catalyst body multiplied by four and divided by the value of the outer perimeter of the outer peripheral wall. When the monolithic structural catalyst body displays a circular cross-sectional geometry, the hydraulic diameter is equal to the diameter of the circular cross-sectional area. In the case of a square cross-sectional geometry, the hydraulic diameter is equal to the length or width of a side. Accordingly, the hydraulic diameter characterizes the size of the monolithic structural adsorber with larger values of hydraulic diameter corresponding to larger monolithic structural adsorbers. In some embodiments, the monolithic structural adsorber has a hydraulic diameter of at least 120 mm or at least 130 mm. The hydraulic diameter of the monolithic structural adsorber can range from 100 mm to 150 mm, from 120 mm to 150 mm, or from 130 mm to 150 mm. In some embodiments, hydraulic diameter of the monolithic structural adsorber can be greater than 150 mm. Hydraulic diameter of the monolithic structure adsorber can have an upper limit of 300 mm, in some embodiments.

In addition to the thin inner partition walls, high OFA, large hydraulic diameter, and high porosity provided by the hierarchical pore structure, the monolithic structural adsorber also exhibits transverse compressive strength sufficient to permit use of the monolithic body in industrial gas treatment applications. Insufficient transverse compressive strength can preclude arrangement or packing of the monolithic structural adsorbers in modules and/or other configurations for industrial gas treatment applications.

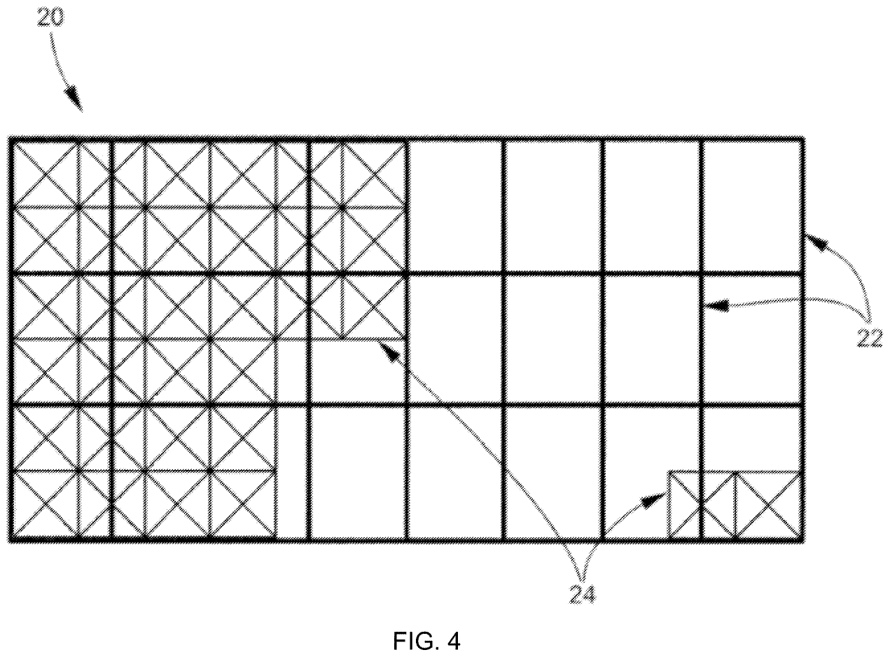

FIG. 4 illustrates a plan view of a module containing monolithic structural adsorbers according to some embodiments. The module 20 comprises an open metal framework 22 for supporting monolithic structural adsorbers 24 disposed therein. The monolithic structural adsorbers 24 are arranged side-by-side. In some embodiments, packing material, cement, or silicone resides between one or more sides of adjacent monolithic adsorbers to prevent gas flow around the monolithic adsorbers. Modules containing the monolithic structural adsorbers can be arranged to form adsorber beds described herein.

When arranged in modules, as in FIG. 4, the monolithic structural adsorbers experience compressive forces resulting from pressure between the adsorbers as they are assembled side-by-side with or without sealing material, and also when stacked on top of each other, with or without sealing material, to form an array large enough to treat a meaningful amount of gas.

In some embodiments, the monolithic structural adsorber exhibits a transverse compressive strength of at least 500 g/cm². Transverse compressive strength of the monolithic structural adsorber can also have a value selected from Table 2.

TABLE 2
Transverse Compressive Strength (g/cm²)

≥600
≥750
≥800
≥1,000
500-1,000
750-1,300

The transverse compressive strengths of the monolithic structural catalyst bodies of the present invention may be measured with a compressive testing apparatus such as Tinius Olson 60,000 lb. Super “L” Compression Testing Machine that displays a maximum compression load of 30,000 kg and can be obtained from Tinius Olsen of Willow Grove, Pa. Samples for transverse compressive strength testing may be prepared by cutting a monolithic structural catalyst into sections typically of 150 mm in length, but at least 50 mm in length, wherein each section can serve as an individual test sample.

Ceramic wool of 6 mm thickness may be spread under and over the pressure surface of the sample, and the wrapped sample set in a vinyl bag in the center of the pressure plates. The pressure plates used in the testing may be stainless steel with dimensions of 160 mm×160 mm. Transverse compression strength is quantified with the side surface on the bottom with the compressive load applied in the direction parallel to the cross-section of the honeycomb structure and perpendicular to the partition walls. The compressive load is thus applied in the direction normal to the direction of flow in the flow channels. The compressive load can be applied as delineated in Table 3.

TABLE 3
Compressive Loads
Compressive Speed
25 kg/s
50 kg/s

The maximum transverse compressive load W (g) withstood by the samples is registered by the apparatus. The transverse compressive strength is subsequently calculated from the maximum compressive load in grams-force (gf) by dividing the value of the maximum compressive load by the surface area over which the load was applied.

When producing monolithic structural adsorbers described herein, lubricants and other extrusion aids are used to reduce shear stress and pressures in processing. Mixing energy, through motor amperage, can be monitored and mixing cycle optimized to minimize mixing energy. Extruder tolerances may be maintained, flow transitions minimized, and/or more positive pressure extruders may be used to minimize shear stresses during extrusion. Dies may be designed to minimize internal pressure losses during extrusion, such as a tapered entrance into the open channels at the entrance of the die. Die surfaces may also be designed to minimize friction in the die, such as polishing inner surfaces and using nickel plating. Conveying systems downstream of the extruder may be designed to minimize forces placed on the extrudate to minimize how stiff the batch must be, such as using foam conveyor surfaces or air bearings.

Monolithic structural adsorbers described herein, in some embodiments, can further comprise inorganic binder and/or reinforcement agents. In some embodiments, inorganic binder and/or one or more reinforcement agents can be present in the monolithic structural adsorber in an amount of 3-30 weight percent. Reinforcement agents can include reinforcing fibers, including glass (SiO₂) fibers, carbide fibers, ceramic fibers, and mixtures thereof. In some embodiments, reinforcing fibers have a diameter of 3 μm to 10 μm. Inorganic binder and/or reinforcement agents can be added to the inorganic oxide extrusion batch. Extrusion conditions described herein are carefully controlled when employing fiber reinforcements as such reinforcements can complicate or interfere with producing the desired mesoporosity and macroporosity of the hierarchical pore structure. The extrusion system may include extruder machines, a filter or screen, and an extrusion die. The filter or screen may be utilized to facilitate passage of the mixture through the die while minimizing shear stresses. Particles that can clog the die are removed without removing filler, binders, glass fibers and/or other reinforcement agents that provide advantageous product properties. In some embodiments, for example, a wedge-shaped screen is employed to prevent or mitigate removal of fiber reinforcements from the mixture.

Monolithic structural adsorbers described herein comprise one or more organic or inorganic chemical species operable for the capture of CO₂ from a gas stream flowed monolithic structural adsorbers. The inner partition walls and outer peripheral wall can support the organic or inorganic chemical species operable for the capture of CO₂. Accordingly, a monolithic structural adsorber not comprising one or more chemical species operable for the capture of CO₂ can be considered a substrate for the one or more chemical species operable for the capture of CO₂. The one or more chemical species operable for the adsorption of CO₂ from the exhaust gas stream can be associated with the carrier exhibiting the hierarchical pore structure described above. The one or more chemical species for CO₂ adsorption can be dispersed throughout the carrier, residing in the mesopores, macropores or combinations thereof of the hierarchical pore structure. In being associated with the carrier, the chemical species for CO₂ adsorption can be dispersed throughout the inner partition walls. Such structure is fundamentally different than a washcoat where a refractory oxide layer is coated onto a substrate as a support for adsorber chemical species.

The chemical species for CO₂ adsorption can be organic compounds or inorganic compounds. In some embodiments, the chemical species comprises one or more organic compounds containing amine functionalities for CO₂ adsorption. For example, the chemical species can comprise one or more polymeric species comprising amine functionalities. In some embodiments, polymeric species comprise polyalkyleneimines, including polyethyleneimine, polypropyleneimine or combinations thereof. Polymeric species comprising amine functionalities for CO₂ adsorption can be linear, branched, or hyper-branched (dendrimer). Polymeric species comprising amine functionalities for CO₂ adsorption can included homopolymers, copolymers, and graft copolymers. Organic compounds comprising amine functionalities for CO₂ adsorption can also include small (non-polymeric) molecules, such as tetra(ethylenepentamine) (TEPA).

As described herein, the organic compounds comprising amine functionalities for CO₂ adsorption can be dispersed throughout the carrier, residing in the mesopores, macropores or combinations thereof of the hierarchical pore structure. In some embodiments, a ratio of organic compound comprising CO₂ capture functionalities residing in the mesopores relative to organic compound comprising CO₂ capture functionalities residing in the macropores is greater than 1. In some embodiments, the ratio ranges from 1.5 to 10 or 2 to 5. Additionally, in some embodiments, at least 80 percent of the organic compound comprising CO₂ capture functionalities resides in the mesopores. In some embodiments, 80 to 90 percent of the organic compound comprising CO₂ capture functionalities resides in the mesopores. Additionally, in some embodiments, at least 75 percent of the organic compound comprising CO₂ capture functionalities resides in the mesopores, wherein total mesopore volume is reduced less than 70 percent by the inclusion of the organic compound.

Organic compounds comprising amine functionalities for CO₂ adsorption can form one or more interactions with the inorganic oxide composition of the carrier. In some embodiments, the organic compounds form van der Waals interactions and/or ionic interactions with the carrier inorganic oxide composition forming the mesopores and/or macropores. In other embodiments, the organic compounds can covalently bind to the inorganic oxide composition. The organic compounds, for example, can comprise one or more functionalities for reacting with surface functionalities of the inorganic oxide, such as hydroxide, oxide, and/or carboxyl surface functionalities. In some embodiments, a chemical linker can be employed to covalently bind the organic compounds comprising amine functionalities to the carrier inorganic oxide composition.

Organic compounds comprising amine functionalities for CO₂ adsorption can partially fill mesopores and/or macropores of the carrier hierarchical pore structure. Additionally, the organic compounds, in some embodiments, can be uniformly or substantially uniformly distributed within the mesopores and/or macropores along the entire length of the flow channels or cells of the monolithic structural adsorber. Organic compounds comprising amine functionalities for CO₂ adsorption, in some embodiments, can be present in the monolithic structural adsorber in an amount of at least 10 weight percent. In some embodiments, the organic compounds are present in the monolithic structural adsorber in an amount of 10 weight percent to 30 weight percent.

In some embodiments, inclusion of organic compounds comprising amine functionalities for CO₂ adsorption in the carrier hierarchical pore structure increases the transverse compressive strength of the monolithic structural adsorber relative to the naked monolithic body. For example, in some embodiments, including one or more organic compounds in at least 40 percent of the mesoporosity increases transverse compressive strength of the monolithic body by at least 50 percent relative to the naked or bare monolithic body.

To facilitate enhanced performance lifetimes of the monolithic structural adsorbers described herein, the inorganic oxide composition of the carrier can be free or substantially free of compounds including metals operable to oxidize the organic compounds comprising amine functionalities for CO₂ adsorption. In some embodiments, the inorganic oxide composition is free or substantially free of compounds, including oxides, comprising metals selected from the group consisting of tungsten, vanadium, iron, chromium, and/or molybdenum. For example, the inorganic oxide of the carrier comprises less than 5 wt. %, less than 3 wt. %, less than 1 wt. % of compounds of tungsten, vanadium, and/or molybdenum. Moreover, the inorganic oxide composition, in some embodiments, includes less than 100 ppm iron or iron compounds, the iron or iron compounds operable for the oxidation and/or other degradation of CO₂ capture functionalities, such as amine functionalities, associated with the carrier.

As an alternative to organic compounds comprising amine functionalities, monolithic structural adsorbers described herein can comprise one or more alkali metal-based functionalities for CO₂ adsorption. In some embodiments, the alkali metal-based functionalities comprise alkali metal oxides operable for CO₂ adsorption. The alkali metal oxides can be dispersed throughout the inorganic oxide composition of the carrier and, therefore, reside in the mesoporosity and/or macroporosity of the hierarchical pore structure. Any alkali metal oxide compound can be employed with monolithic structural adsorbers described herein. In some embodiments, for example, the alkali metal oxide comprises alkali metal carbonates, including sodium carbonate and/or potassium carbonate.

Monolithic structural adsorbers comprising organic compounds or inorganic compounds for CO₂ capture can exhibit a mesoporosity greater than 0.05 cc/g in pores of diameter ranging from 20 to 500 Angstroms. Mesoporosity of the monolithic structural adsorbers comprising organic compounds or inorganic compounds for CO₂ capture is measured via nitrogen (N₂) adsorption.

As described herein, the exhaust gas stream is flowed through at least one bed formed of the monolithic structural adsorbers to remove at least 70 percent CO₂ from the exhaust gas stream, wherein the exhaust has stream an inlet temperature of at least 60° C., a CO₂ content of 3-20 percent, and a water vapor content of 2-22 percent. In some embodiments, the exhaust gas stream has an inlet temperature of 60-95° C. The exhaust gas stream can be subjected to upstream processing prior to entry into one or more of the adsorber beds. The exhaust gas stream, for example, may be subject to selective catalytic reduction (SCR) processing to remove nitrogen oxides and/or mercury from the exhaust gas stream. Additionally, the exhaust gas stream may be mixed with other gasses, such as ambient air, to cool, dry, and/or dilute the CO₂ content of the exhaust gas stream. In some embodiments, the exhaust gas stream is passed through one or more filters upstream of the inlet to one or more adsorber beds. The filter(s) can remove particulate matter harmful to the monolithic structural adsorbers, including metal oxide particles that promote degradation of CO₂ adsorption functionalities and particles that can clog or otherwise inhibit gas flow through flow channels of the monolithic structural adsorbers. In some embodiments, one or more filters remove 20-95% of particles having a size of 0.3 μm or greater.

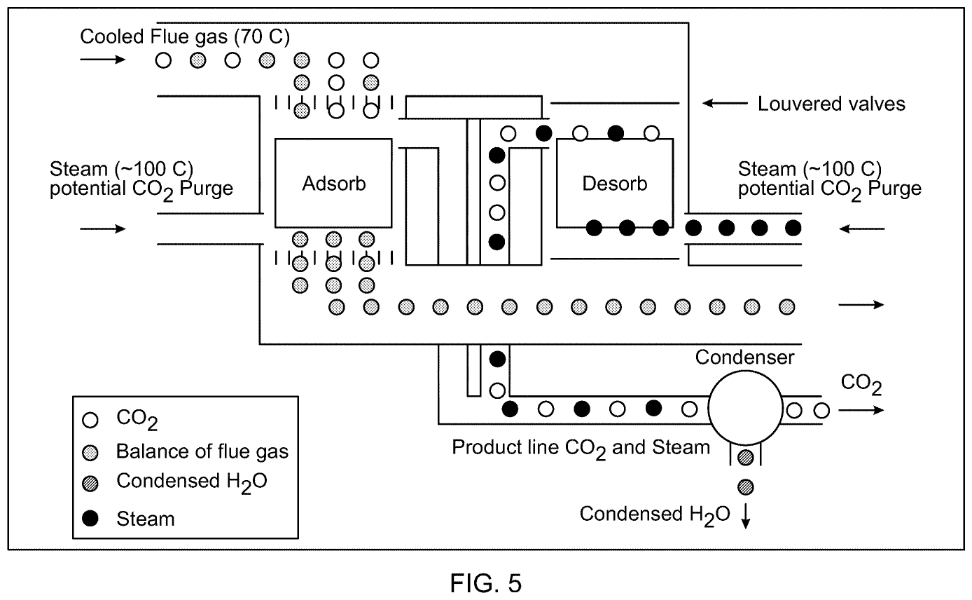

After flowing the exhaust gas stream through the one or more beds and adsorbing CO₂ from the exhaust gas stream with the monolithic structural adsorbers, the adsorber bed is isolated from the exhaust gas stream. The one or more beds having adsorbed CO₂ can be isolated from the gas stream by closing valves, louvers or other panels through which the exhaust gas stream flows. The valves, louvers or other panels can have a stationary position in that the valves, louvers, or other panels do not travel or change location in the CO₂ removal system. Moreover, the adsorber beds are also stationary and non-moving, in some embodiments. FIG. 5 discussed below further illustrates these principles.

Once isolated, steam at a pressure of −2 psig to 2 psig and temperature of 96-120° C. is flowed through the adsorber bed in a direction opposite the exhaust gas stream flow to desorb the CO₂ captured by the adsorber bed by providing enthalpy for CO₂ desorption. A first portion of the steam is condensed in pores of the monolithic structural adsorbers, and a second portion of the steam sweeps the desorbed CO₂ from the adsorber bed to provide a mixture of the desorbed CO₂ and sweeping steam. The CO₂ is then separated from the mixture, thereby providing a product gas with at least 90 percent CO₂ by weight. In some embodiments, the mixture of desorbed CO₂ and sweeping steam is cooled to condense the steam thereby providing the product gas with at least 90 percent CO₂ by weight. The product gas, in some embodiments, comprises 90-99 percent CO₂ by weight.

In some embodiments, at least 1 percent or at least 10 percent of the adsorbed CO₂ remains on the monolithic structural adsorbers after the steam desorption process. The remaining CO₂ can protect the organic or inorganic CO₂ adsorption functionalities of the monolithic structural adsorbers from degradation, thereby prolonging lifetime of the structural adsorbers. In some embodiments, 1-20 percent of the desorbed CO₂ remains on the monolithic structural adsorbers after the steam desorption process. Moreover, the change in ammonia concentration in the exhaust gas stream from the inlet to the outlet of the adsorber bed is less than an average of 2 ppm during adsorption of CO₂ from the exhaust gas stream. Ammonia content in the exhaust gas stream is measured using an FTIR multi-gas analyzer with ppb level sensitivity in high water content gas streams. Increases in ammonia concentration at the outlet of the adsorber bed can indicate decomposition or degradation of amine CO₂ adsorber functionalities in the bed.

Isolation of the adsorber bed from the exhaust has stream is discontinued, and the exhaust gas stream re-enters the monolithic structural adsorbers to evaporate the condensed steam in the pores and cool the adsorbers to a temperature less than 90° C. to begin a new adsorption cycle.

In some embodiments, methods described herein employ at least two adsorber beds, wherein at any given time, a first adsorber bed is removing CO₂ from the exhaust gas stream, while a second adsorber bed is isolated from the exhaust gas stream and desorbing CO₂ captured by the monolithic structural adsorbers. The CO₂ adsorption by the first bed and the CO₂ desorption from the second bed occurs according to the procedure detailed above.

FIG. 5 is a schematic illustrating methods described herein, according to some embodiments. In the embodiment of FIG. 5 a first adsorber bed (Adsorb) having construction and properties described herein is removing CO₂ from an exhaust or flue gas stream. The cooled flue gas (70° C.) flows through louvered valves and into the adsorber bed where CO₂ (black dots) is removed from the flue gas stream via adsorption by the monolithic structural adsorbers of the bed. A second adsorber bed (Desorb) having construction and properties described herein is undergoing the CO₂ desorption process via exposure to steam (gray circles). The louvered valves permitting flue gas flow to the second adsorber bed are closed, thereby isolating the second adsorber bed from the flue gas stream during the CO₂ desorption process. As described herein, the steam flows into the second adsorber bed in a direction opposite of the flue gas pathway through the second adsorber bed. The resulting mixture of desorbed CO₂ and sweeping steam (black and gray circles) travels to a condenser for cooling, thereby condensing the steam and providing a product gas with at least 90 percent CO₂ by weight.

Additionally, in some embodiments, a condensing heat exchanger (not shown in FIG. 5) may be installed downstream of the adsorber bed to enable recovery of steam that was condensed in the adsorber bed during desorption. The total amount of water recovered from the condensing heat exchanger plus the amount removed during separation from CO₂ product resulting from desorption is equivalent to at least 90% of steam introduced to the adsorber bed during desorption. In some embodiments, the heat exchanger also recovers at least 2 percent of water vapor in the exhaust gas stream produced by the combustion process.

These and other embodiments are further illustrated in the following non-limiting examples.

### Example 1—CO₂ Removal from Exhaust Gas Stream

A monolithic structural adsorber having the parameters in Table 4 was placed in a testing chamber for quantifying removal of CO₂ from an exhaust gas stream.

TABLE 4
Monolithic Structural Adsorber

| Parameter | Value | |
|---|---|---|
| Composition | Titania | |
| cpsi | 170 | |
| Inner partition walls thickness | 0.23 | mm |
| Open Frontal Area | 77% | |
| Hydraulic Diameter | 145 | mm |
| Mesoporosity | 0.08 | cc/g |
| PEI loading | 14 | wt. % |

One CO₂ adsorption/desorption cycle on the testing system was run as follows. A simulated feed gas containing CO₂ was injected over the monolith adsorber part at a space velocity of 2483 h⁻¹. The exhaust gas stream had an average CO₂ content at the inlet of the monolithic structural adsorber of 4.2%, an average water content at the inlet of 17.4%, and an average inlet temperature of 88.4° C. The CO₂ capture effectiveness was quantified by simultaneously measuring the inlet and outlet CO₂ concentrations and using the following formula: C.E.=[1−(Σ CO₂out*Δt)/(Σ CO₂out*Δt)]*100%, wherein Δt=5 s; sum from 0 to 120 s

After the adsorption step was completed, the feed gas was switched off (by directing it to a second adsorber chamber) and steam was flowed through the monolithic structural adsorber from the opposite side of the adsorber part; this steam provided both the heat required to desorb the CO₂ from the monolithic structural adsorber and the sweep gas to collect the desorbed CO₂. The steam/CO₂ mixture was flowed through a condensing heat exchanger to remove the water; resulting CO₂ stream is compressed and stored in a tank. A slipstream flow, pulled from the transfer line between the compressor and the storage tank, is analyzed by a high concentration range CO₂ analyzer to quantify the CO₂ purity. The outlet of this CO₂ analyzer is then fed back to the compressor inlet to recover the analyzed CO₂. The results of the testing were a CO₂ capture effectiveness (C.E.) of 97.7% and a product gas with 94.6 weight % CO₂.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A method for removal of CO₂ from an exhaust gas stream comprising:
flowing an exhaust gas stream produced by a point source through at least one adsorber bed formed of monolithic structural adsorbers, the monolithic structural adsorbers comprising an outer peripheral wall and a plurality of inner partition walls supporting an organic compound or inorganic compound adsorbing CO₂ from the exhaust gas stream, wherein the exhaust gas stream has an inlet temperature of at least 60° C., a CO₂ content of 3-20 percent, and a water vapor content of 2-22 percent;
isolating the adsorber bed from the exhaust gas stream;
flowing steam having a pressure of −2 psig to 2 psig and a maximum temperature of 120° C. through the monolithic structural adsorbers in a direction opposite of the exhaust gas stream flow to desorb the CO₂ captured by the adsorber bed by providing enthalpy for CO₂ desorption;
condensing a first portion of the steam in pores of the monolithic structural adsorbers;
sweeping the desorbed CO₂ from the adsorber bed with a second portion of the steam to provide a mixture of the desorbed CO₂ and sweeping steam;
separating the desorbed CO₂ from the mixture thereby providing a product gas with at least 90 percent CO₂ by weight; and
discontinuing isolation of the adsorber bed from the exhaust gas stream, wherein the exhaust gas stream re-enters the monolithic structural adsorbers to evaporate at least some of the first portion of steam condensed in the pores and cool the adsorbers to a temperature less than 90° C. to begin a new adsorption cycle.

2. The method of claim 1, wherein the at least one adsorber bed comprises a first adsorber bed removing CO₂ from the exhaust gas stream, while a second adsorber bed is simultaneously isolated from the exhaust gas stream and is desorbing CO₂ captured by the monolithic structural adsorbers.

3. The method of claim 1, wherein at least 1 percent of the CO₂ captured from the exhaust gas stream remains on the monolithic structural adsorbers after desorption and prior to discontinuing the isolation of the adsorber bed from the exhaust gas stream.

4. The method of claim 3, wherein at least 1-10 percent of the CO₂ captured from the exhaust gas stream remains on the monolithic structural adsorbers after desorption and prior to discontinuing the isolation of the adsorber bed from the exhaust gas stream.

5. The method of claim 3, where in the organic compound is present on the monolithic structural adsorbers and comprises amine functionalities.

6. The method of claim 5, wherein the organic compound comprises polyalkyleneimine.

7. The method of claim 6, wherein the polyalkyleneimine is polyethyleneimine.

8. The method of claim 5, wherein a change in ammonia concentration in the exhaust gas stream from inlet to outlet of the adsorber bed is less than an average of 2 ppm during adsorption of CO₂ from the exhaust gas stream.

9. The method of claim 1 further comprising positioning at least one filter upstream of the adsorber bed, the filter removing at least 50 percent of particles having a size of 0.3 μm or greater.

10. The method of claim 1 further comprising installing a condensing heat exchanger downstream of the adsorber bed, wherein the condensing heat exchanger recovers at least 2 percent of water vapor in the exhaust gas stream produced by the combustion process.

11. The method of claim 1 further comprising installing a condensing heat exchanger downstream of the adsorber bed to enable recovery of steam that was condensed in the adsorber bed during desorption, wherein the total amount of water recovered from the condensing heat exchanger plus the amount removed during separation from CO₂ product resulting from desorption is equivalent to at least 90% of steam introduced to the adsorber bed during desorption.

12. The method of claim 1, wherein the monolithic structural adsorbers exhibit a mesoporosity of at least 0.05 cc/g in pores having diameter of 20-500 Angstroms.

13. The method of claim 1, wherein the outer peripheral wall and the plurality of inner partition walls comprise have a carrier dispersed throughout, the carrier comprising an inorganic oxide composition.

14. The method of claim 13, wherein the carrier exhibits a hierarchical pore structure having a macroporosity of at least 0.05 cc/gin pores of diameter ranging from 600 to 5,000 Angstroms, and a mesoporosity of at least 0.15 cc/g pores of diameter ranging from 20 to 500 Angstroms.

15. The method of claim 14, wherein the organic compound or inorganic compound adsorbing CO₂ from the exhaust gas stream can be dispersed throughout the carrier, residing in the mesopores, macropores or combinations thereof of the hierarchical pore structure.

16. The method of claim 1, wherein the monolithic structural adsorbers each have a cell density of at least 85 cpi.

17. The method of claim 1, wherein the monolithic structural adsorbers each have an open frontal area of at least 65 percent.

18. The method of claim 1, wherein the monolithic structural adsorbers each exhibit a transverse compressive strength of at least 500 g/cm².

19. The method of claim 1, wherein the inner partition walls have a thickness of 0.1 mm to 0.3 mm.

20. The method of claim 1, wherein at least 70 percent of CO₂ from the exhaust gas stream is removed.
